(19) United States
(12) Patent Application Publication
(10) Pub. No.: US 2006/0016303 A1
(43) Pub. Date: Jan. 26, 2006

(54) Driver tool

(75) Inventor: Qiu Jian Ping, Hangzhou (CN)

Correspondence Address: WILLIAM COLLARD;COLLARD & ROE, P.C., 1077 NORTHERN BOULEVARD, ROSLYN, NY, 11576, US

(73) Assignee: Great Neck Saw Manufacturers, Inc.

(21) Appl. No.: 10/894,785

(22) Filed: Jul. 20, 2004

(51) Int. Cl. B25B 23/16; B25G 1/08

(52) U.S. Cl. 81/490; 81/177.4; 81/439

(57) ABSTRACT

A driver tool having a hollow handle and a head. The head has a body portion and a mouth portion. A plurality of channels formed in body portion each of which is adapted to receive a driver. A selector assembly is mounted within body portion and comprises an exit groove and a stop gate located between said mouth portion and the channels. An exit notch is provided in the stop gate which communicates with the exit groove. Rotation of the selector assembly relative to the handle to move the exit groove and the exit notch past the channels so that when the rotation is stopped when the exit groove and the exit notch are opposite a predetermined channel permits a driver in that channel may move from the channel into the exit groove through the exit notch and thereby freeing a driver in the exit groove to move out of the exit groove through the mouth portion and to protrude out of the handle assembly to an extended position. The driver is held in the extended position and the stop gate prevents the other drivers in the other of said channels from moving out of the channels.

### BACKGROUND

The present invention relates to a driver tool or similar article and more particularly to a driver tool or a similar article, such as a screwdriver, in which the driver may be retracted into the handle.

Retractable driver tools have been known for a number of years and comprise the use of a number of drivers with different heads and/or bits, such as straight or phillips screwdriver bits. The drivers are usually stored within the handle and when a particular driver is needed, that driver is moved out of the handle and placed in an operative position in front of the handle. When that driver is no longer needed it is retracted back into the handle.

In some of these tools the drivers are physically removed from and physically replaced in the handle so that there is the possibility that the driver may be dropped or lost in transit. Other tools use various complicated and expensive mechanisms to extend the required driver out of the handle and to replace it back into the handle.

### OBJECTS

The present invention overcomes these problems and has for one of its objects the provision of an improved retractable driver tool in which a number of drivers may be easily stored in the handle, in which a selected driver may be easily placed in its extended operative position when desired, and in which the selected driver may be easily retracted into the handle.

Another object of the present invention is the provision of an improved retractable driver tool in which each driver is moved in and out of the handle without the driver being physically disengaged from the handle.

Another object of the present invention is the provision of an improved retractable driver tool which is simple and inexpensive to operate and maintain.

Other and further objects of the invention will be obvious upon an understanding of the illustrative embodiment about to described, or will be indicated in the appended claims and various advantages not referred to herein will occur to one skilled in the art upon employment of the invention in practice.

### DRAWINGS

A preferred embodiment of the invention has been chosen for purposes of illustration and description and is shown in the accompanying drawings forming a part of the specification, wherein:

FIG. 1 is an exploded perspective view of a driver tool made in accordance with the present invention.

FIG. 2 is a perspective view of the driver tool in its operative position.

FIG. 3 is sectional view taken along line 3-3 of FIG. 2.

FIG. 4 is a sectional view similar to FIG. 3 showing the driver tool with its drivers in their retracted positions.

FIG. 5 is a sectional view similar to FIG. 4 showing a driver in a partially extended position.

FIG. 6 is a fragmentary sectional view showing the position of the parts when a driver is in its extended position.

FIG. 7 is a fragmentary sectional view similar to FIG. 6 showing the position of the parts when a driver is being retracted.

FIG. 8 is a sectional view taken along lines 8-8 of FIG. 4.

FIG. 9 is a sectional view taken along line 9-9 of FIG. 7.

FIG. 10 is a sectional view taken along line 10-10 of FIG. 3.

FIG. 11 is a plan view of the end cap.

FIG. 12 is a sectional view taken along line 12-12 of FIG. 5.

FIG. 13 is a perspective view of the end cap of the present invention showing the controller being inserted therein.

FIG. 14 is a similar perspective view showing the controller fully inserted in the end cap.

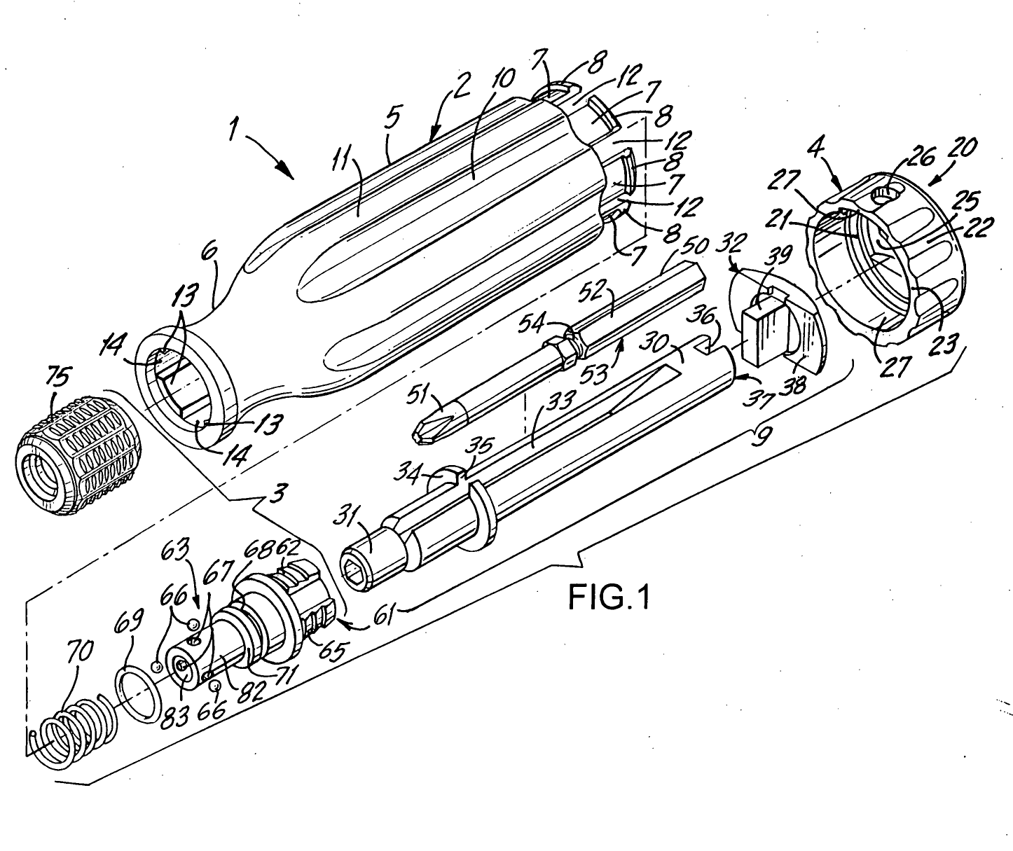

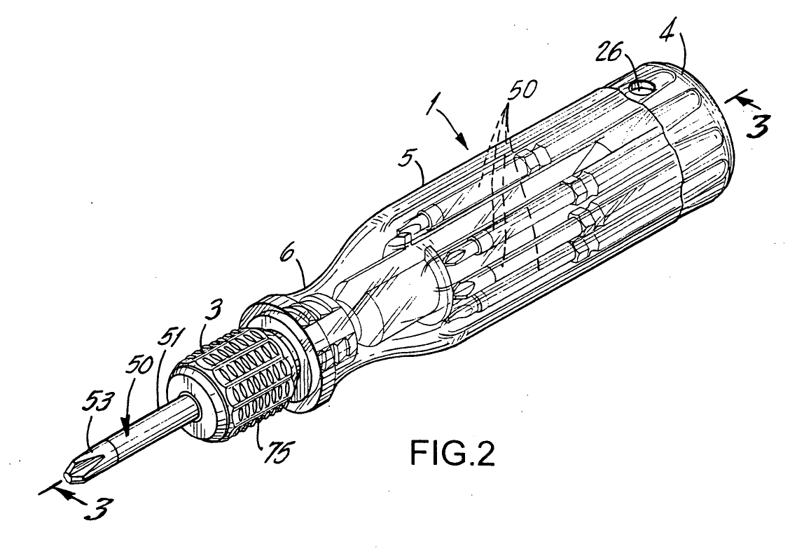

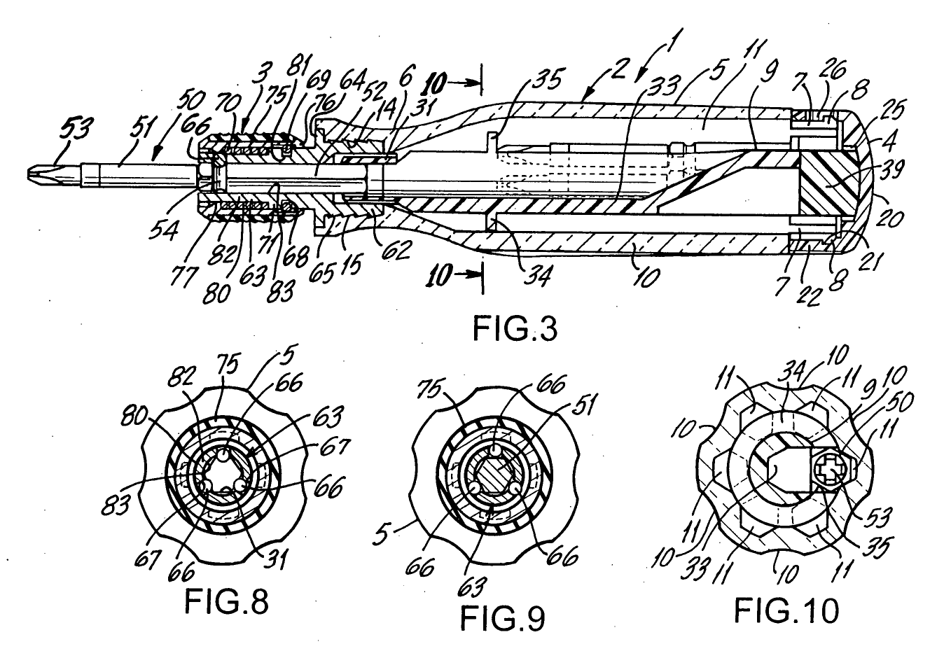

### DESCRIPTION

Referring to the drawings, the driver tool 1 of the present invention comprises a handle assembly 2, a head assembly 3 and an end cap 4 adopted to be mounted at the rear of the handle assembly.

The drivers 50 which are preferably used with the present invention are elongated and comprise a body 51, a head 53 and a rear 52. The head 53 may be comprised of a shaped driver bit, such as a straight or phillips screwdriver. The rear 52 is non-circular in cross section and preferably has a hexagonal cross section. A groove 54 is provided approximately midway on the body 51 and separates the head 51 from the rear 52.

The handle assembly 2 is hollow and comprises a main body portion 5, a head portion 6, and a selector assembly 9 mounted within the hollow body portion 5.

Parallel to the long axis of the main body portion 5, the main body portion 5 has a plurality of spaced substantially parallel elongated inwardly directed grooves 10 which form outwardly directed driver-receiving channels 11 therebetween. Each channel 11 is adapted to receive a driver 50 therein. A plurality of spaced lock fingers 7 extend rearwardly from the grooves 10 in the main body portion 5 with the spaces 12 formed between them being co-extensive with the driver-receiving channels 11. Each lock finger 7 has an outwardly extending flange 8 at its end. The head portion 6 is narrower than the main body portion 5 and has a plurality of spaced separators 13 on its inner surface 15 to form grooves 14 therebetween.

The end cap 4 is mounted on the rear end of the handle assembly 2 and has a rear wall 20 and an upstanding skirt 22 with an internal circumferential groove 21 formed therein. The outwardly extending flanges 8 of the spaced lock fingers 7 are adapted to enter into the groove 21 in order to permit the end cap 4 to be mounted on and held in place on the rear of the main body portion 5 and to permit the end cap 4 to rotate relative to the main body portion 5. The end cap 4 has a cavity 25 in its rear wall 20 and a viewing opening 26 in its skirt 22.

The selector assembly 9 is mounted within the main body portion 5 of the handle assembly 2 and comprises an elongated body 30, an open front mouth 31 and a controller 32. The open front mouth 31 is non-circular and is similar in size and configuration to the size and configuration of the non-circular rear 52 of the drivers 50 and is preferably hexagonal. The body 30 of the selector assembly 9 has an elongated exit groove 33 therein which communicates with and leads into the open front mouth 31 thereof. The body 30 of the selector assembly 9 is also provided with a circumferential stop ring 34 extending therefrom. The stop ring 34 is provided with a notch 35 which overlies and communicates with the exit groove 33. A slot 36 is provided at the rear end edge 37 of the selector assembly 9 which preferably is in linear alignment with the exit groove 33 in the selector assembly 9. The controller 32 is keyed to and/or is affixed to the rear end edge 37 of the main body 30 and comprises a base 38 and an upstanding key 39. The key 39 is adapted to enter the slot 36 in the rear edge 37 of the main body 30 so that rotation of the controller 32 will rotate the entire selector assembly 9. The base 38 is adapted to be mounted in the end cap 4 and to enter the groove 25 so that rotation of the end cap 4 will rotate the entire selector assembly 9 through the intermediation of the key 38 and slot 36. When the base 38 is mounted in the groove 25, the viewing opening 26 is positioned in axial alignment with the groove 33 in selector assembly 9 and above the rear 52 of the drivers 50 so that user is always aware of the position of the groove 33 in the selector assembly 9.

Rotation of the selector assembly 9 moves the exit groove 33 and notch 35 in stop ring 34 past and below each of the drivers 50 in the channels 11 in the handle 2. The viewing opening 26 also moves past the rear ends 52 of the drivers 50 from above so that when the user sees the desired driver 50, rotation of the end cap 4 is stopped at that position which also stops the selector assembly 9 with its groove 33 at that same position. When the selector assembly 9 is stopped so that its groove 33 is beneath the desired driver 50 in a its channel 11, the driver 50 will fall into the exit groove 33 through the notch 35. The selected driver 50 can now move out of the selector assembly 9 through the hexagonal open front mouth 31 of the main body 30 until its hexagonal rear 52 sits in the hexagonal open mouth 31 and is held in place therein, as will be referred to herewith. The stop ring 34 prevents the other drivers 50 from moving forward out of their channels 11 toward the head portion 6 of the handle assembly 3.

The head assembly 3 comprises hollow tubular body 60 and an outer control sleeve 75 slidably mounted thereon. The body 60 has rear end 61, a front end 63 and a shoulder 64 separating the two. The rear end 61 has spaced lock fingers 62 with reentrant fins 65 adapted to be inserted into the head potion 6 of the main body outer 5 of the handle assembly 2 in the spaces 14 formed between the separators 13 in the inner surface 15 of the head portion 6 so as to fit tightly into the head portion 6 of the handle assembly 5 and be held in place by the reentrance fins 65.

The front end 63 has a plurality of balls 66 mounted in and movable within spaced pockets 67 formed therein. The spaced pockets 67 extend through the walls 82 of the front end 63 to from the outer surface 80 thereof to the inner surface 81 thereof. The diameter of the balls 66 is slightly larger than the diameter of the mouths 67A of the pockets 67 so that outer surfaces of the balls 66 can extend within the inner surface 81 and into the interior cavity 83 of the front end 63 but cannot fall out of the pockets 67. A circumferential groove 68 is provided in front 63 and a stop ring 69 is adapted to be mounted in the groove 68. A spring 70 is mounted over outer surface 80 of the front end 63 and abuts against a shoulder 71 formed by the groove 68.

The slidable control sleeve 75 is mounted over the spring 70 and over the entire front end 63. The control sleeve 75 has a rear flange 76 and front tab 77 extending inwardly therefrom. The spring 70 is held between the said front flange 77 and the shoulder 71 in the front end 63. The control sleeve 75 has an enlarged groove 78 in its inner surface adjacent the rear flange 76 so as to receive the stop ring 69 therein so that control sleeve 75 is held securely on the front end 63 for slidable movement thereon and cannot fall off the front end 63. The balls 66 in the front end 63 are adapted to move within their pockets 65 so that the balls 66 can protrude beyond the inner surface 81 of the front end 63 and into its interior 83 but are free to move back into their pockets 67 above the inner surface 81. When the control sleeve 75 is in its forward position (FIG. 6) the front flange 77 is adapted to strike the balls 66 and move them down so that their outer surface moves beyond the inner surface 81 of the front end 63 and into the interior 83 thereof and hold them in that position. When the control sleeve 75 is moved backward (FIG. 7) against the bias of the spring 70, the front flange 77 is moved away from the balls 66 so that the balls 66 are free to move back up in their pockets 67and out of the interior 83 of the front end 63.

When a driver 50 is to be moved to its extended position (FIGS. 5 and 7) it is moved forward to a position in which its groove 53 is opposite the pockets 67 so that the balls 66 move down into the groove 53 of the drivers 50 through the inner surface 81. The control sleeve 75 is moved to its rear position with the tab 77 away from behind the balls 66 so that the balls 66 are free to move back and froth within their pockets 67 in the interior 83 of the front end 63. As the driver 50 moves forward (FIG. 7) it strikes the balls 66 and moves them up into their pockets and out of the way. When the driver reaches its forward-most position its groove 54 is now opposite the pockets 67 of the balls 66 which now fall into the groove 54. The control sleeve 77 is now released and moves forward under the influence of spring 70 so that the front flange 77 now lies over the balls 66 and holds the balls 66 in the groove 53 in the driver 50. This locks the driver 50 in place in its extended position. When it is desired to retract the driver 50 and move it back into its channel 11 in the handle assembly 2, the control sleeve 75 is again moved back against the action of the spring 70 to move the front flange 77 away from over the balls 66 to release them and be provided back by the driver 50 into their pockets 65 and out of the groove 53 in the driver 50 thereby permitting the driver 50 to move back into the handle assembly 2 and back into its channel 11 by passing through the exit groove 33 in the selector assembly 9.

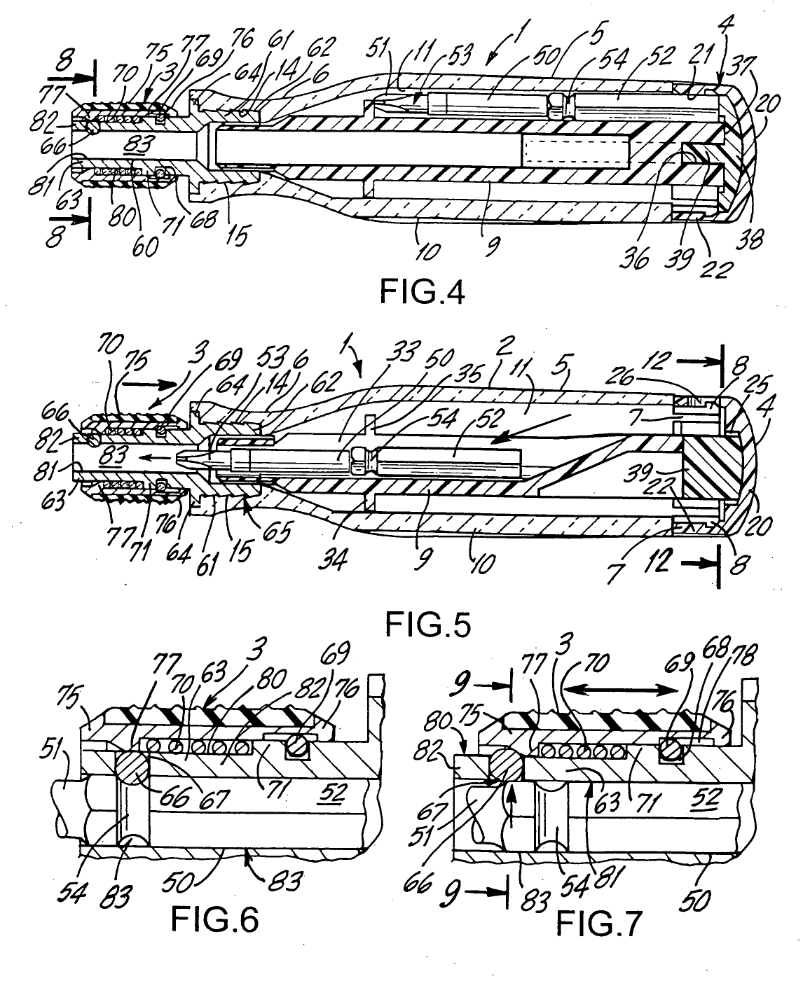

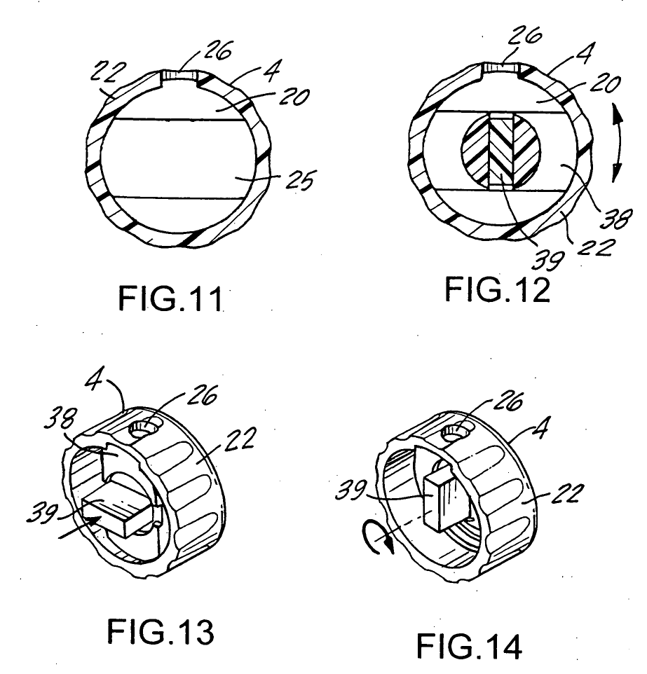

In operation the driver tool is originally in the position shown in FIG. 4 with all of the drivers 50 in the their respective channels 11 in the handle assembly 3 and the control sleeve 75 in its forward position with its tab 77 urging the balls 66 down protruding into the interior 83 in the front end 63. When it is desired to select a particular driver 50, the end cap 4 is rotated and which in turn rotates the selector assembly 9. The viewing opening 26 in the end cap 3 permits the user to see the rear 52 of each driver 50 that the viewing opening 26 passes over. When a desired driver 50 is reached, rotation of the end cap 3 is stopped. The selected driver 50 now falls down into the exit groove 33 in the selector assembly 9 past the notch 35 in the stop ring 34. It is now free to move forward out into the selector assembly 9 and into the front end 63. As shown in FIGS. 5 and 7 the control sleeve 75 is moved back against bias of spring 70 to permit the balls 66 to be retracted outwardly as the driver 50 is moving past the balls 66. When the driver 50 reaches its forward most position, the groove 54 therein is now opposite the balls 66 which fall into the groove 54. At this point, the control sleeve 75 as released and moves forwardly, by spring 70 so that its tab 77 lies over the balls 66 to hold them in their position in the groove 54 of the driver 50 to hold the driver 50 in its extended position. It may now be used without any fear of the driver 50 being pushed back into the handle assembly 2.

When it is desired to move the extended driver 50 back into the handle assembly 2, the control sleeve 75 is moved backwardly (FIG. 7) to move the tab 77 away from the balls 66 so that the balls 66 are free to move back in their pockets 67. The driver 50 is now in a position to move the balls upwardly back into their pockets 67 as the driver 50 is moving backwards into the handle assembly 2. The driver 50 moves back through the open front end 63 and back into the exit groove 30 in the selector assembly 9 and into its original channel 11. Rotation of the end cap 3 again will hold that particular driver in its channel 11 because the notch 35 in the stop rind 34 moves away from that particular channel so that the driver 50 cannot be moved out of its channel because the stop ring permits it.

It will thus be seen that the present invention provides an improved retractable driver tool in which a number of drivers may be easily stored in the handle and in which a selected driver may be easily placed in its extended operative position when desired and easily moved back into its retracted position in which each driver may be moved in and out of the handle without the driver being physically disengaged from the handle and which is simple and inexpensive to operate and maintain.

As many and varied modifications of the subject matter of this invention will become apparent to those skilled in the art from the detailed description given hereinabove, it will be understood that the present invention is limited only as provided in the claims appended hereto.

The embodiments of the invention in which an exclusive property or privilege is claimed are defined as follows:

1. A driver tool comprising a hollow handle assembly and a head assembly, said handle assembly having a body portion and a mouth portion, a plurality of channels formed in said body portion each of which is adapted to receive a driver therein, a selector assembly mounted within said body portion, said selector assembly comprising an exit groove and a stop gate, said stop gate being located between said mouth portion and said channels, an exit notch in said stop gate communicating with said exit groove, means for rotating the selector assembly relative to the handle to move the exit groove and the exit notch past said channels whereby stopping said rotation when the said exit groove and the said exit notch are opposite a predetermined channel permits a driver in that channel to move from the channel into said exit groove through said exit notch and thereby freeing a driver in the exit groove to move out of the exit groove through said mouth portion and to protrude out of the handle assembly to an extended position, means for holding the driver in said extended position, and whereby said stop gate prevents drivers in the other of said channels from moving out of said channels.

2. A driver as set forth in claim 1, wherein means are provided to permit the driver to move back into the body portion of said handle assembly through the intermediation of said exit groove and said exit notch in said stop gate.

3. A driver tool as set forth in claim 2 wherein said selector assembly comprises a body having a front and rear end, said front end being hollow and communicating with said exit groove.

4. A driver tool as set forth in claim 3 wherein the rear end of the body has a controller mounted thereon.

5. A driver tool as set forth in claim 4 wherein said controller comprises a base and an upstanding key.

6. A driver tool as set forth in claim 7 wherein a slot is provided in said rear end of the body and wherein said key is mounted within said slot whereby rotation of said controller rotates the body of said selector assembly.

7. A driver tool as set forth in claim 6 wherein an end cap is mounted on said handle and is rotatable relative to said handle and said end cap having means operatively associated with said controller whereby rotation of the end cap rotates the body of said selector assembly through the intermediation of said controller.

8. Driver tool as set forth in claim 7, wherein said skirt has a viewing opening in linear alignment with said exit groove.

9. A driver tool as set forth in claim 8 wherein said end cap has an end wall and an upstanding skirt portion and wherein said end wall is provided with a cavity adapted to receive the base of said controller.

10. A driver tool as set forth in claim 9 wherein the skirt of said end cap has a groove and wherein said handle has spaced lock fingers extending rearwardly therefrom, said fingers having flanges extending outwardly and positioned in said groove.

11. A driver tool as set forth in claim 10 wherein said head assembly comprises a hollow body having a front end and a rear end, said rear end being mounted within the mouth portion of the handle and communicating with and in alignment with the hollow front end of the selector assembly portion, said front end having exterior and interior surfaces and at least one ball-receiving pocket connecting said two surfaces, a ball mounted in a said pocket and a control sleeve mounted over said front end.

12. A driver tool as set forth in claim 11 wherein said control sleeve is slidable on said front end and wherein the control sleeve has an inwardly extending flange.

13. A driver tool as set forth in claim 12 wherein a stop ring is mounted on said front end and wherein a stop groove is provided in said control sleeve adjacent to said flange, said stop ring being positioned within the stop groove to prevent the control sleeve from moving off of the front end.

14. A driver tool as set forth in claim 13 wherein the control sleeve has an inwardly extending lock tab spaced from said flange, said lock tab adapted to overly said ball to exert pressure on said balls when the control sleeve is in a predetermined position protruding through to keep the ball in an extended position in the interior surface and to prevent the ball from extending out of its pocket into the said exterior surface.

15. A driver tool as set forth in claim 14 wherein a spring is mounted on the front end beneath said control sleeve to bias the control sleeve in the direction away from the handle to said predetermined position where the said lock tab overlies said ball whereby movement of said control sleeve against the bias of said spring moves the tab away from its predetermined position overlying said ball to permit the ball to move out of said interior surface.

16. A driver tool as set forth in claim 15, wherein said means for holding the driver in an extended position comprises a groove in the driver and said ball cooperating with said groove to hold the driver in its extended position and wherein said lock tab overlies said ball to keep said ball in cooperation with said groove.

17. A driver tool as set forth in claim 16 wherein said means for permitting the driver to move back into the handle comprises said control sleeve mounted on said front end being moved out of its predetermined position against the bias of the said spring to move the lock tab away from a position overlying the ball to permit the ball to move out of the groove in the driver and free the driver to move back into the handle.

18. A driver tool as set forth in claim 1 wherein an end cap is mounted on said handle and is rotatable relative to said handle and said end cap having means operatively associated with said controller whereby rotation of the end cap rotates the body of said selector assembly.

19. Driver tool as set forth in claim 18, wherein said skirt has a viewing opening in linear alignment with said exit groove.

20. A driver tool as set forth in claim 19 wherein said end cap has an end wall and an upstanding skirt portion and wherein said end wall is provided with means adapted to be operatively associated with said selector assembly.

21. A driver tool as set forth in claim 20 wherein the skirt of said end cap has a groove and wherein said handle has spaced lock fingers extending rearwardly therefrom, said fingers having flanges extending outwardly and positioned in said groove.

22. A driver tool as set forth in claim 1 wherein said head assembly comprises a hollow body having a front end and a rear end, said rear end being mounted within the mouth portion of the handle and communicating with and in alignment with the hollow front end of the selector assembly portion, said front end having exterior and interior surfaces and at least one ball-receiving pocket connecting said two surfaces, a ball mounted in a said pocket and a control sleeve mounted over said front end.

23. A driver tool as set forth in claim 22 wherein said control sleeve is slidable on said front end and wherein the control sleeve has an inwardly extending flange.

24. A driver tool as set forth in claim 23 wherein a stop ring is mounted on said front end and wherein a stop groove is provided in said control sleeve adjacent to said flange, said stop ring being positioned within the stop groove to prevent the control sleeve from moving off of the front end.

25. A driver tool as set forth in claim 24 wherein the control sleeve has an inwardly extending lock tab spaced from said flange, said lock tab adapted to overly said ball to exert pressure on said balls when the control sleeve is in a predetermined position protruding through to keep the ball in an extended position in the interior surface and to prevent the ball from extending out of its pocket into the said exterior surface.

26. A driver tool as set forth in claim 25 wherein a spring is mounted on the front end beneath said control sleeve to bias the control sleeve in the direction away from the handle to said predetermined position where the said lock tab overlies said ball whereby movement of said control sleeve against the bias of said spring moves the tab away from its predetermined position overlying said ball to permit the ball to move out of said interior surface.

27. A driver tool as set forth in claim 26, wherein said means for holding the driver in an extended position comprises a groove in the driver and said ball cooperating with said groove to hold the driver in its extended position and wherein said lock tab overlies said ball to keep said ball in cooperation with said groove.

28. A driver tool as set forth in claim 27 wherein said means for permitting the driver to move back into the handle comprises said control sleeve mounted on said front end being moved out of its predetermined position against the bias of the said spring to move the lock tab away from a position overlying the ball to permit the ball to move out of the groove in the driver and free the driver to move back into the handle.
